(19) United States
(12) Patent Application Publication
(10) Pub. No.: US 2008/0058578 A1
(43) Pub. Date: Mar. 6, 2008

(54) Method for Reducing the Dioxin Content of Bleaching Earth

(76) Inventors: Werner Zschau, Steinebach (DE); Klaus Schurz, Munchen (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(21) Appl. No.: 11/547,273

(22) PCT Filed: Mar. 8, 2005
(86) PCT No.: PCT/EP05/02433

§ 371 Date: Jun. 6, 2007

(30) Foreign Application Priority Data
Mar. 12, 2004 (DE) 10 2004 012 259.8

(51) Int. Cl. B01J 20/12; C01B 33/38; C01B 33/40; C01B 33/42

(52) U.S. Cl. 588/318; 588/321; 588/409

(57) ABSTRACT

A process is described for reducing the dioxin content of a composition comprising at least one dioxin-containing raw clay or a dioxin-containing bleaching earth, characterized in that the composition is heated to a temperature in the range of about 125 to 650° C.

Bleaching earths have found use for many decades in the purification of oils and fats. In the production of the bleaching earths, principally two processes are employed, specifically the acid activation of naturally inactive smectites, in particular of montmorillonite-containing raw clays in a slurry process using large amounts of acid, and the use of naturally active raw clays which are optionally activated with small amounts of acid in a wastewater-free process. The disadvantage of the first process is that it is coupled with large amounts of acidic wastewater. However, very active bleaching earths are obtained in this process. The bleaching power of the products produced by the second process is usually somewhat lower, but the simple production process allows inexpensive and environmentally friendly production.

Irrespective of their production method, bleaching earths are used principally to process and to purify cooking oils and fats. Since the products produced with the aid of bleaching earths enter the food chain, they have to be produced with very low impurities. Since used bleaching earths are in many cases used in the feeds industry, it is also necessary for the bleaching earths which do not intrinsically pass any harmful substances to cooking oils to achieve minimum harmful substance contaminations.

One of the most feared contaminations in foods is by dioxins and dibenzofurans. According to a recommendation of FEDIOL (La Fédération de l'Industrie de l'Huilerie de l'UE, the EU Seed Crushers' and Oil Processors' Federation), bleaching earths should contain less than 1 ng/kg I-TEQ (toxicity equivalents) of dioxins/dibenzofurans.

The pollution of the environment with dioxins in an ubiquitous problem. Most dioxins stem from anthropogenic sources, but dioxins are also found in some deeper clay-bearing strata and clearly cannot be attributed to any human activities. According to recent investigations, dioxins have been generated during the deposition of these strata via biocatalytic syntheses from 2,4,6-trichlorophenol which may itself have been formed by the action of exogenic bacterial chloroperoxidases from the phenol present in organic materials. These theses are supported by the finding of anthropogenic dioxins, owing to the low mobility of dioxins in the soil, virtually exclusively in the upper layers. In addition, the distribution of the congeners (isomers having different position of the chlorine atoms) of the dioxins present in clays from low layers has an unusual pattern. The absence of dibenzofurans which are typical companions of anthropogenic dioxins also points to an unusual formation history.

Irrespective of the use of bleaching earths and the source of the dioxins, it is an object of the present invention to produce low-dioxin or substantially dioxin-free clay or bleaching earth products. In particular, bleaching earths should be produced from naturally active raw clays or from dioxin-contaminated bleaching earths. It is also an aim of the invention that the dioxin removal step should not result in any disadvantages having to be accepted with regard to cleaning performance or bleaching activity of the resulting products.

This object is achieved by the process according to claim 1. Preferred embodiments are specified in the subclaims.

The invention thus provides a process for reducing the dioxin content of a composition comprising at least one dioxin-containing raw clay or a dioxin-containing bleaching earth, characterized in that the composition is heated to a temperature in the range of about 125 to 650° C.

The composition consists preferably to an extent of at least 50%, in particular to an extent of at least 75%, more preferably to an extent of at least 90%, of raw clay and/or bleaching earth. In a particularly preferred embodiment, the compositions consist substantially or fully of raw clay and/or bleaching earth.

In the context of the present invention, raw clay refers to a naturally active or naturally inactive clay material, which also includes clay materials which have been activated by conventional mechanical or chemical workup steps, but, in delimitation from the bleaching earths, not in a (separate) activation step. Accordingly, bleaching earth refers in the context of the present invention to a clay material activated (in an activation step), in particular by thermal and/or acid treatment. The term bleaching earth is familiar to those skilled in the art and includes activated clay materials which, owing to their adsorption or bleaching activity, can be used for purification, especially of cooking oils and fats.

According to the invention, all naturally active and naturally inactive raw clays and fresh or used bleaching earths (i.e. activated raw clays) familiar to those skilled in the art may be used, in particular di- and trioctahedral sheet silicates of the serpentine, kaolin and talc pyrophyllite group, smectites, vermiculites, illites and chlorites, and of the sepiolite-palygorskite group, for example montmorillonite, neutronite, saponite and vermiculite or hectorite, beidellite, palygorskite and mixed layer minerals. It is of course also possible to use mixtures of two or more of the aforementioned materials. Equally, the composition used in accordance with the invention, comprising at least one dioxin-containing raw clay and/or a dioxin-containing bleaching earth, may also contain further constituents which do not impair the intended use of the composition, in particular its bleaching activity, or even have useful properties.

In a preferred embodiment of the invention, the composition used is a dioxin-containing bleaching earth or a dioxin-containing raw clay, and it is possible with the aid of the process according to the invention to produce a low-dioxin or substantially dioxin-free bleaching earth or raw clay.

“Dioxins” refer to chlorinated dibenzodioxins, but also the analogous dibenzofurans. The term “dioxin(s)” is used hereinbelow representatively of these substance classes.

According to the invention, reduction of the dioxin content refers to any lowering of the dioxin content of the composition after the process according to the invention has been carried out in comparison to the starting material. The dioxin content of the composition is reduced preferably from above 1 ng I-TEQ/kg to below 1 ng I-TEQ/kg, in particular to below about 0.7 ng I-TEQ/kg.

It is common knowledge that high temperatures destroy the lattice structures of an active bleaching earth, which decreases the bleaching activity. Overall, the raw clays and bleaching earths used in accordance with the invention are materials whose usability can be impaired by high temperatures, for example, owing to a disadvantageous alteration of the lattice structure. It has now been shown that, surprisingly, at temperatures between about 125 and 650° C., in particular between about 300 and 600° C., and more preferably of about 410 to 600° C., dioxins present in the starting material used (raw clay or bleaching earth) can be degraded, in particular without loss of usability of the raw clay or of the bleaching earth. Especially at the higher temperature ranges, the dioxin contents have been lowered in some cases down to the limit of detection. Particularly good results were achieved at a temperature between about 450 and 550° C. (600° C.).

In addition, it has been found that, surprisingly, the heating step can be carried out in one stage and without use of an inert gas atmosphere (for example nitrogen or steam or the like), and particularly good results can be achieved with this simple process. In a particularly preferred embodiment of the invention, the heating step is carried out in an oxygenous atmosphere, in particular an air atmosphere.

In a particularly preferred embodiment, after the heating, a rehydration is carried out to a moisture content of about 3.0 to 14% by weight, in particular of about 5.0 to 11% by weight, more preferably of about 7.0 to 10% by weight, optionally associated with an acid activation, as a result of which, surprisingly, no losses in the bleaching activity of the product have to be accepted.

On the contrary, it has been found that, unexpectedly, in the case of an acid activation of the raw clay or else of the bleaching earth, after the heating step, both particularly low-dioxin and particularly active bleaching earths are obtained. It has also been found that it is preferable in many cases to provide for the acid activation directly after the heating, i.e. before an optional rehydration.

The acid treatment may be carried out with at least one organic or inorganic acid in dissolved form or as a solid. When a composition comprising a naturally active raw clay or a bleaching earth is used, the acid treatment is effected preferably with 1 to 10% by weight of acid. When a composition comprising a naturally inactive raw clay is used, preferably 20 to 70% by weight of acid, in particular inorganic acid, is used in some cases.

An acid treatment (acid activation) carried out after the heating step can even achieve distinctly improved bleaching activities, or adsorption or decolourization activities.

In general, the inventive activation of the raw clays can be carried out by a treatment with acid. To this end, the raw clays are contacted with an inorganic or organic acid. In principle, any process for acid activation of clays which is known to those skilled in the art may be used, including the processes disclosed in WO 99/02256, U.S. Pat. No. 5,008,226 and U.S. Pat. No. 5,869,415, which in this respect are incorporated explicitly by reference into the description.

In a preferred inventive embodiment, it is not necessary for the excess acid and the salts formed in the activation to be washed out. Instead, after the acid has been added, no washing step is carried out as is customary in the acid activation, but rather the treated raw clay is dried and then ground to the desired particle size. In the grinding, a typical bleaching earth fineness is usually established. For this fineness, the dry sieve residue on a sieve having a mesh width of 63 μm is in the range from 20 to 40% by weight. The dry sieve residue on a sieve having a mesh width of 25 μm is in the range from 50 to 65% by weight.

In one possible embodiment of the process according to the invention, the activation of the raw clay is carried out in the aqueous phase. The acid is contacted as an aqueous solution with the raw clay. The procedure may also be to initially slurry the raw clay, which is preferably provided in the form of a powder, in water. Subsequently, the acid (for example in concentrated form) is added. However, the raw clay may also be slurried directly in an aqueous solution of the acid, or the aqueous solution of the acid may be added to the raw clay. In an advantageous embodiment, the aqueous acid solution may be sprayed, for example, onto a preferably crushed or pulverulent (raw) clay, in which case the minimum amount of water is preferably selected and, for example, a concentrated acid or acid solution is used. The amount of acid may in many cases be selected preferably between 1 and 10% by weight, more preferably between 2 and 6% by weight, of a strong acid, in particular of a mineral acid such as sulphuric acid, based on the dry raw clay. However, it is also possible and may in some cases be advantageous to use higher amounts of acid. Where necessary, excess water can be evaporated off and the activated raw clay then ground to the desired fineness. Preference is given to drying to the desired moisture content. Usually, the water content of the resulting bleaching earth product is adjusted to a fraction of less than 20% by weight, preferably less than 10% by weight.

For the above-described activation with an aqueous solution of an acid or of a concentrated acid, the acid may itself be selected arbitrarily. It is possible to use either mineral acids or organic acids, or mixtures of the aforementioned acids. It is possible to use customary mineral acids such as hydrochloric acid, phosphoric acid or sulphuric acid, of which preference is given to sulphuric acid. It is possible to use concentrated or dilute acids or acid solutions. The organic acids used may be, for example, citric acid or oxalic acid. Preference is given to citric acid. Preferably, but not obligatorily, the raw clay is not calcined before the acid treatment.

The particle size, i.e. the average particle size, of the inventive adsorbent should preferably be selected in such a way that, in a later use of the activated raw clay or of the bleaching earth, a full and simple removal of the clay from the refined product is enabled. In one inventive embodiment, the average particle size of the pulverulent raw clay is selected within a range of from 10 to 63 μm. Typically, the fineness is selected in such a way that about 20 to 40% of the mixture remains on a sieve having a mesh width of 63 μm (sieve residue) and about 50 to 65% by weight of the mixture remains on a sieve having a mesh width of 25 μm. This can be referred to as a typical bleaching earth fineness.

As already explained, it is possible by the process according to the invention to provide adsorbents and bleaching earth products in a simple and inexpensive manner, whose adsorption and bleaching activity is surprisingly high and is in some respects above the activity of conventional highly active bleaching earths.

A calcination after the acid activation is not required, but not ruled out.

The amount of acid used for activation is selected in such a way that it firstly achieves sufficient activation (with regard especially to adsorption, bleaching and/or decolourization activity of the material, preferably in the treatment of cooking oils and fats) of the (raw) clay but secondly there is no excess loading with acid. The amount to be used depends upon the nature of the acid used, for example its acid strength. The suitable amount of acid may be determined by those skilled in the art by simple preliminary experiments. When the (raw) clay and the acid are mixed, the presence of further (solid) components is generally not required, but not ruled out in accordance with the invention. The above-described acid activation of the raw clay or of the bleaching earth may also be carried out before the inventive heating step.

Suitable inorganic acids are, for example, hydrochloric acid, sulphuric acid and/or phosphoric acid for activation of the raw clay or of the bleaching earth, especially in the case of naturally inactive raw clays.

The dioxin-containing raw clay and the dioxin-containing bleaching earth used preferably have a specific surface area of more than 50 m²/g and a pore volume of more than about 0.1 ml/g, determined by the analytical methods below.

In a further aspect of the invention, it has been found that dioxins are in some cases extremely strongly fixed to dried raw clays or bleaching earths, so that they can no longer be detected by the currently employed analytical methods (extraction with organic solvents at 140° C. and 80 bar of pressure), so that it is falsely assumed that the raw clays do not contain any dioxins. However, when the identical material is rehydrated to a moisture content of about 3.0 to 14% by weight, in particular of 8 to 10% by weight, the dioxins present therein are again analytically detectable.

It is possible with the simple process according to the invention, surprisingly, to obtain low-dioxin bleaching earths which have a very good activity, for example in the bleaching of oils and fats. In addition to the above-described process for preparing a low-dioxin bleaching earth product, the invention therefore further provides a low-dioxin bleaching earth product itself which is obtainable by the above-described process.

The invention further provides the use of this low-dioxin bleaching earth product for refining oils and fats. Particular preference is given to using the low-dioxin bleaching earth product for the refining of (vegetable) oils. The low-dioxin bleaching earth product is suitable in particular for the decolourization and for the removal of chlorophylls from oils and fats.

The following analytical methods were employed:

Surface area: The specific surface area was determined by the BET method with a fully automatic nitrogen porosimeter from Micromeritics, model ASAP 2010, to DIN 66131.

Pore volume: The pore volume is determined by the CCl₄ method (H. A. Benesi, R. V. Bonnar, C. F. Lee, Anal. Chem. 27 (1955), page 1963). To determine the pore volumes for different pore diameter ranges, defined partial CCl₄ vapour pressures were established by mixing CCl₄ with paraffin.

Oil analysis: The colour number in oils (Lovibond method) was determined to AOCS Cc 13b-45. Chlorophyll A was determined to AOCS Cc 13d-55.

Water content: The water content of the products was determined at 105° C. using the method DIN/ISO-787/2 by drying in a drying cabinet for 2 hours.

Dioxin analysis: The determination of the dioxins/di-benzofurans was carried out by a licensed laboratory. The evaluation was by the WHO method (cf. Official Journal of the European Communities, Vol. 45, 6 Aug. 2002, L209/5-L209/14). The analysis with regard to the dioxins is carried out as follows:

The samples are adjusted to a moisture content of 8.5% by weight. Where it is not possible to establish such a high moisture content for certain samples, the highest possible moisture content is established in a controlled-climate chamber.

After the internal standard mixture has been added, about 30 to 50 g of sample are then extracted with toluene as the solvent by means of ASE (accelerated Soxhlet extraction) at 140° C. and 80 bar over a treatment time of 25 min. The extract is purified on a mixed silica gel column (22% NaOH-silica, neutral silica, 44% H₂SO₄-silica), followed by a chromatographic separation on alumina.

After the recovery standards below have been added, the eluate from the alumina column is concentrated to the suitable end volume in a nitrogen stream and subsequently analyzed for the 17 dioxin types (PCDD/PCDF) by means of high-resolution gas chromatography (injection by means of cold evaporation, column: DB-dioxin) and high-resolution mass spectroscopy (electron impact ionization, 2 ions per degree of chlorination (native and internal standard)). The quantification was by means of the isotope dilution method.

The following internally labeled ¹³C12 standards were used:

2378-TCDD

12378-PeCDD

123678-HxCDD

1234678-HpCDD

OCDD

2378-TCDF

23478-PeCDF

123678-HxCDF

123789-HxCDF

1234678-HpCDF

OCDF

The following recovery standard was used:

³⁷C14-2378-TCDD

¹³C12-1234789-HpCDF

In the examples and comparative examples which follow, which are only reported for illustration, the following clay qualities were used:

Clay 1:
Naturally occurring clay mixture of attapulgite and
montmorillonite from Georgia, USA:

| | |
|---|---|
| Pore volume: | 0.24 ml/g |
| Specific surface area: | 154 m²/g |
| Dioxin content: | 6.6 ng I-TEQ/kg |

Clay 2:
Mexican hormite:

| | |
|---|---|
| Pore volume: | 0.26 ml/g |
| Specific surface area: | 176 m²/g |
| Dioxin content: | 5.4 ng I-TEQ/kg |

Clay 3:
HCl-activated montmorillonite (bleaching earth):

| | |
|---|---|
| Pore volume: | 0.35 ml/g |
| Specific surface area: | 244 m²/g |
| Dioxin content: | 9.4 ng I-TEQ/kg |

Clay 4:
Turkish montmorillonite:

| | |
|---|---|
| Pore volume: | 0.15 ml/g |
| Specific surface area: | 115 m²/g |
| Dioxin content: | 6.5 ng I-TEQ/kg |

### COMPARATIVE EXAMPLE

### Preparation of a Bleaching Earth from Clay 1

A mine-moist raw clay 1 was predried to a moisture content of 15-20% by weight, ground using a rotary hammer mill and subsequently brought to a final moisture content of 8% by weight. 100 g of the resulting powder were mixed intimately with 309 g of water and 2.88 g of H₂SO₄ (96%) in a beaker. The resulting mixture was dried to a water content of 9% by weight at 110° C. and subsequently ground to a typical bleaching earth fineness (dry sieve residue (TSR)>63μ=29%).

The dioxin content of the thus obtained bleaching earths was determined to be 6.4 ng I-TEQ/kg.

### EXAMPLE 1

### Dioxin Removal from Attapulgite/Montmorillonite (Clay 1)

The mine-moist raw clay 1 was predried to 15-20% by weight of water and subsequently ground using a rotary hammer mill. The resulting powder was divided into equal portions which were each treated at temperatures of 150, 300, 400, 450, 500 and 600° C. for one hour. The materials present in dry form after the thermal treatment were rehydrated to water contents of 8 to 9% in a controlled-climate cabinet at 30° C. and 80% atmospheric humidity. The sample which had been heated at 600° C. only attained a water content of 7.7% by weight in the rehydration.

Table I below reports the measured dioxin contents of the treated samples by the WHO method.

TABLE I
Dioxin removal from clay 1

| | Dioxin content | H₂O content after | Dioxin content |
|---|---|---|---|
| T | (calcined) | rehydration | (rehydrated) |
| (° C.) | (ng I-TEQ/kg) | (%) | (ng I-TEQ/kg) |
| 125 | 0.17 | 9.0 | 6.6 |
| 200 | 0.12 | 9.1 | 5.5 |
| 300 | 0.09 | 8.4 | 2.1 |
| 400 | 0.08 | 8.3 | 1.7 |
| 450 | 0.07 | 8.4 | 1.0 |
| 500 | 0.07 | 8.3 | 0.23 |
| 600 | 0.07 | 7.7 | 0.11 |

Table I shows that, from a temperature of 200° C., a slight decomposition and, from a temperature of 300° C., a distinct decomposition of dioxins occurs, and the limiting value of 1 ng I-TEQ/kg discussed by FEDIOL is attained at 450° C. However, it should be pointed out here once again that these values become measurable only after the rehydration (right-hand column of Table I). In the dry (calcined), non-rehydrated material (left-hand column), in contrast, analysis always finds values which are much too low.

### EXAMPLE 2

### Dioxin Removal from Hormite (Clay 2)

The starting material (Mexican hormite) was processed analogously to Example 1. The data obtained in this process are summarized in Table II.

TABLE I
Dioxin removal from clay 2

| | Dioxin content | H₂O content after | Dioxin content |
|---|---|---|---|
| T | (calcined) | rehydration | (rehydrated) |
| (° C.) | (ng I-TEQ/kg) | (%) | (ng I-TEQ/kg) |
| 125 | 0.18 | 8.6 | 5.4 |
| 200 | 0.13 | 8.7 | 3.9 |
| 300 | 0.09 | 8.2 | 1.3 |
| 400 | 0.08 | 8.1 | 0.93 |
| 500 | 0.08 | 8.3 | 0.21 |
| 600 | 0.07 | 7.5 | 0.10 |

Table II shows that, from a temperature of 300° C., a distinct degradation of dioxins and furans occurs, and the value goes below 1 ng I-TEQ/kg at 400° C.

### EXAMPLE 3

### Dioxin Removal from a Bleaching Earth (Clay 3)

The starting material, a montmorillonite activated with hydrochloric acid in a slurry process, was treated at temperatures of 125° C. and 500° C. and analyzed analogously to Example 1. The data obtained in this process are compiled in Table III.

TABLE III
Dioxin removal from clay 3

| | Dioxin content | H₂O content after | Dioxin content |
|---|---|---|---|
| T | (calcined) | rehydration | (rehydrated) |
| (° C.) | (ng I-TEQ/kg) | (%) | (ng I-TEQ/kg) |
| 125 | 0.23 | 10.6 | 9.4 |
| 500 | 0.09 | 7.9 | 0.29 |

### EXAMPLE 4

### Dioxin Removal from Montmorillonite (Clay 4)

The starting material (montmorillonite) was processed at temperatures of 125° C. and 500° C. analogously to Example 1. The data obtained in this process are compiled in Table IV.

TABLE IV
Dioxin removal from clay 4

| | Dioxin content | H₂O content after | Dioxin content |
|---|---|---|---|
| T | (calcined) | rehydration | (rehydrated) |
| (° C.) | (ng I-TEQ/kg) | (%) | (ng I-TEQ/kg) |
| 125 | 0.16 | 11.2 | 6.5 |
| 500 | 0.07 | 8.0 | 0.19 |

### EXAMPLE 5

### Preparation of a Bleaching Earth by Activating an Attapulgite/Montmorillonite Mixture with Sulphuric Acid

The product of Example 1 which had been calcined at 500° C. was mixed with water and subsequently activated with 4% H₂SO₄. To this end, 100 g of the calcined powder were mixed intimately with 250 g of water and 4.17 g of H₂SO₄ (96%) in a beaker. The resulting mixture was dried at 110° C. to a water content of 9% by weight and subsequently ground to bleaching earth fineness. (Dry sieve residue on 63 μm sieve 20 to 40% by weight; dry sieve residue on 25 μm sieve 50 to 65% by weight).

### EXAMPLE 6

### Preparation of Bleaching Earths by Acid Activation of Montmorillonite (Clay 4)

The product from Example 4 was mixed with water and hydrochloric acid. To this end, 100 g of the powder which had been calcined at 500° C. were converted using 300 g of water and 112.5 g of HCl (32%) in a round-bottomed flask and activated under reflux for 6 hours. The suspension was filtered, the filtercake was extracted by washing to chloride content <0.1%, dried to a water content of 9.5% and subsequently ground to bleaching earth fineness.

### USE EXAMPLE

### Bleaching of Rapeseed Oil

A degreased and deacidified rapeseed oil was bleached with 0.73% by weight of bleaching earth at 110° C. for 30 min under a pressure of 30 mbar. Subsequently, the bleaching earth was filtered off, and the colour numbers of the oil were determined with the aid of the Lovibond method in a 5¼″ cuvette. Table V reproduces the results of the bleaching:

TABLE V
Bleaching of rapeseed oil

| | Lovibond colour | Chlorophyll A |
|---|---|---|
| | number red | ppm |
| Raw oil, | >20 (1″ cuvette): | 3.26 |
| unbleached | 4.7 | |
| Ex. 3 | 2.2 | 0.12 |
| (500° C., | | |
| rehydrated) | | |
| Ex. 5 (H₂SO₄) | 3.1 | 0.20 |
| Ex. 6 (HCl) | 1.9 | 0.09 |
| Comparative | 3.4 | 0.22 |
| example | | |
| Tonsil Optimum ® | 2.1 | 0.11 |
| 210 FF | | |

As Table V clearly shows, better decolourization (colour number red and chlorophyll A) is achieved with the inventive products according to Example 5 and 6 than with the product according to the comparative example.

In the product class of the acid-activated smectites (Example 3, 6 and Tonsil Optimum® 210 FF, a highly active bleaching earth, commercial product from Süd-Chemie AG), it was possible with the process according to the invention to achieve bleaching results which at least correspond to the prior art.

1. Process for reducing the dioxin content of a composition comprising at least one dioxin-containing raw clay or a dioxin-containing bleaching earth, characterized in that the composition is heated to a temperature in the range of about 125 to 650° C.

2. (canceled)

3. Process according to claim 1, characterized in that the composition is heated to a temperature in the range from about 400 to 600° C.

4. (canceled)

5. Process according to claim 1, characterized in that, after heating, rehydrating the heated composition to a moisture content of about 3.0 to 14% by weight.

6. Process according to claim 5, characterized in that the composition, after heating and before rehydration, is subjected to an acid treatment.

7. Process according to claim 6, characterized in that the acid treatment is carried out with at least one inorganic or organic acid.

8. Process according to claim 6, characterized in that the acid treatment is effected in the case of a naturally active raw clay or bleaching earth by utilizing from 1 to 10% by weight of acid.

9. Process according to claim 1, characterized in that the dioxin-containing raw clay or the dioxin-containing bleaching earth used has a specific surface area of more than 50 m²/g and a pore volume of more than 0.1 ml/g.

10. Process according to claim 7, characterized in that the inorganic acid used for the acid treatment is selected from hydrochloric acid, sulphuric acid and phosphoric acid, and the organic acid used for the acid treatment is selected from citric acid and oxalic acid.

11. (canceled)

12. Process according to claim 6, characterized in that, in the acid treatment, the composition is contacted with the acid when the composition is in the form of a slurry after it has been heated.

13. Process according to claim 6 characterized in that the acid treatment is effected in the case of naturally inactive raw clay by utilizing from 20 to 70% by weight of an acid.

14. A process for reducing the dioxin content of a composition comprising at least one dioxin-containing raw clay or a dioxin-containing bleaching earth comprising heating the composition to a temperature in the range of 450° C. to 600° C., acid treating the composition with an inorganic or organic acid without the additional step of washing the treated composition; drying; and grinding the treated composition.

15. The process according to claim 14, characterized in that, after heating, rehydrating the heated composition to a moisture content of about 3.0 to 14% by weight.

16. The process according to claim 14, characterized in that the acid treatment is effected in the case of a naturally active raw clay or a bleaching earth by utilizing from 1 to 10% by weight of acid.

17. The process according to claim 14 characterized in that the acid treatment is effected in the case of naturally inactive raw clay by utilizing from 20 to 70% by weight of an acid.

18. The process according to claim 14, characterized in that the dioxin-containing raw clay or the dioxin-containing bleaching earth used has a specific surface area of more than 50 m²/g and a pore volume of more than 0.1 ml/g.

19. The process according to claim 14, characterized in that the inorganic acid used for the acid treatment is selected from hydrochloric acid, sulphuric acid and phosphoric acid, and the organic acid used for the acid treatment is selected from citric acid and oxalic acid.

20. The process according to claim 14, characterized in that during the acid treatment, the composition is contacted after it has been heated with the acid while the composition is in the form of a slurry.

21. A process for reducing the dioxin content of a composition comprising at least one dioxin-containing raw clay or a dioxin-containing bleaching earth comprising heating the composition to a temperature in the range of 300° C. to 600° C., acid treating the composition in an aqueous phase with an inorganic or organic acid, drying and grinding the composition to produce a reduced dioxin content bleaching earth.

22. The process according to claim 21, characterized in that the acid treatment is effected in the case of a naturally active raw clay or a bleaching earth by utilizing from 1 to 10% by weight of acid.

23. The process according to claim 21, characterized in that the dioxin-containing raw clay or the dioxin-containing bleaching earth used has a specific surface area of more than 50 m²/g and a pore volume of more than 0.1 ml/g.
